(19) United States
(12) Patent Application Publication
(10) Pub. No.: US 2019/0091892 A1
(43) Pub. Date: Mar. 28, 2019

(54) Power Tool Drill Bit Cooling Device

(71) Applicant: David Lomauro, Whiting, NJ (US)

(72) Inventor: David Lomauro, Whiting, NJ (US)

(21) Appl. No.: 15/714,281

(22) Filed: Sep. 25, 2017

(51) Int. Cl. B28D 7/02; B28D 1/14

(52) U.S. Cl. CPC B28D 7/02; B28D 1/14; B23B 41/00; B23B 2250/12; B23B 2226/75

(57) ABSTRACT

This invention affords the power drill operator the ability to adjust the flow of water to maximize the cooling and cleaning effect upon the diamond drill bit being used, and after it is set upon the tile surface, no other adjustments are needed, allowing the operator greater safety and precision in using the drill with both hands while greatly extending the life of the expensive diamond studded drill bit.

### BACKGROUND OF THE INVENTION

In the construction industry, installation of bathroom or kitchen appliances and fixtures usually occurs after the tile/wall covering, flooring, and countertops are installed. With the advent of stone countertops and tiles coming onto the market, with their various colors and types, has created quite a demand, which the industry is more than happy to meet. These new stone tiles and countertops are much harder than traditional materials. This creates a problem for anyone who wishes to install a fixture or anything that necessitates the drilling of holes in these tiles or countertops. The tool industry has come out with diamond studded drill bits and hole saws for drilling in these very hard substances. The only problem is that these are very expensive and don't last more than a few uses. There are a few different types of devices that try to provide water cooling for the purpose of extending the life of the bit, but they prove to be inadequate or ineffective, or both.

### BRIEF SUMMERY OF THE INVENTION

The invention is designed to provide adequate cooling and remove debris from the drill site while drilling, thus extending the life of the drill bit being used to drill a hole into very hard stone tile. The invention consists of a collapsable plastic bladder, that is filled with water, and is suspended above the drill site. How this bladder is suspended is dependent on the circumstances. If the tile is smooth, the provided suction cup that is attached to one corner of the bladder will be sufficient to hold its weight. If the tile is not smooth a short piece of tape, such as duct tape or something similar, will work nicely. At the bottom of the bladder is a valve that allows the user to adjust the water flow to provide the desired rate of flow to accomplish the cooling and debris removal. After the water leaves the valve it passes through a short piece of stiff hose that points the water stream directly on the bit for cooling. Under the whole assembly it is desirable to affix a shop rag to the tile beneath the drill site to catch any debris and soak up the water as to minimize mess.

This invention allows the user to setup the device and then use both hands to drill the hole without the need to use one hand to drill and the other to dispense water. The previous method frequently resulted in the hole being drilled inaccurately, or potentially scarring the surface of the tile due to the drill bit shifting while the operator is trying to start the hole.

With the valve, the user can adjust the flow of water to meet the cooling and debris removal requirements of the bit being used, allowing one device to be used with several size drill bits, unlike some devices already on the market.

### BRIEF DESCRIPTION OF THE DRAWINGS

FIG. 1

This figure depicts the preferred embodiment of the invention, consisting of the suction cup for affixing the device to the tile, the collapsible bladder filled with water, the control valve assembly, for adjusting the flow of water, and the semi-rigid tube for directing the flow onto the bit to keep it cool and clean.

FIG. 2

This figure depicts the control valve assembly of the invention.

FIG. 3

This figure depicts another embodiment of the invention, with an alternative method of suspension for rough surfaces, consisting of the suction cup that is only used for smooth surfaces, the collapsible bladder filled with water, the control valve assembly, for adjusting the flow of water, the rigid tube for directing the flow onto the bit to keep it cool, and the tape used to suspend the device when the tile is rough.

FIG. 4

This figure depicts another embodiment of the invention, consisting of two suction cups for affixing the device to the tile, on an angle, the collapsible bladder filled with water, the control valve assembly, for adjusting the flow of water, and the rigid tube for directing the flow onto the bit to keep it cool. This embodiment of the device would be used in the event of needing to drill a hole up high and there is not enough clearance for the invention to be suspended completely vertically, or inside a cabinet where space is limited.

FIG. 5

This figure depicts an embodiment of the invention, consisting of a suction cup for affixing the device to the tile, the collapsible bladder filled with water, the alternate control valve assembly, for adjusting the flow of water, and allowing for easy filling of the bladder on the job-site, and the rigid tube for directing the flow onto the bit to keep it cool.

FIG. 6

This figure depicts, in detail, the alternate control valve assembly, that allows for easy refilling of the bladder.

FIG. 7

This figure depicts another embodiment of the invention, consisting of the suction cup for affixing the device to the tile, the large capacity collapsible bladder filled with water, for longer drill time between refills, the control valve assembly, for adjusting the flow of water, and the semi-rigid tube for directing the flow onto the bit to keep it cool and clean.

FIG. 8

This figure depicts the preferred embodiment of the invention, suspended from a movable frame in-order to facilitate drilling vertically, as into countertops or other flat surfaces.

FIG. 9

This figure depicts the on-site fill device for the preferred embodiment of the invention.

### DETAILED DESCRIPTION OF THE INVENTION

This invention was created for a specific purpose, to solve one specific problem, that the Inventor encountered in his chosen profession. The building industry has started installing very hard stone tile in the bathrooms and kitchens of many new homes. These very hard tiles destroy the diamond studded drill bits that are used to install fixtures. In most cases only one or two holes can be drilled before the drill bit is no longer useful. The expense of these diamond studded bits are not negligible. The Inventor bought several different devices on the market that were supposed to solve this problem. Each of these devices had shortcomings that were unacceptable. one such device had special adhesive pads that affixed to the tile and the chamber that adhered to the pad was filled with water and the drill bit was inserted into the hole provided for it. The devise worked adequately, but each size drill-bit would require another size chamber, necessitating the installer to cary several of these devices, and also the added expense of purchasing more of the special adhesive pads that are not reusable. Another device had a chamber that the installer would fill mostly with water and pressurize with the built in hand pump. This chamber had a thin tube that attached to a fixture that facilitated the drilling of various size holes, but it again was affixed to the tiles with a special adhesive pad, that was not reusable. The inventor was looking for one device that could be filled with water and affixed to the tile and the flow rate set. It should be small and easy to carry, and one unit should facilitate any size drill-bit that the average user would use. None was found to satisfy all the design criteria.

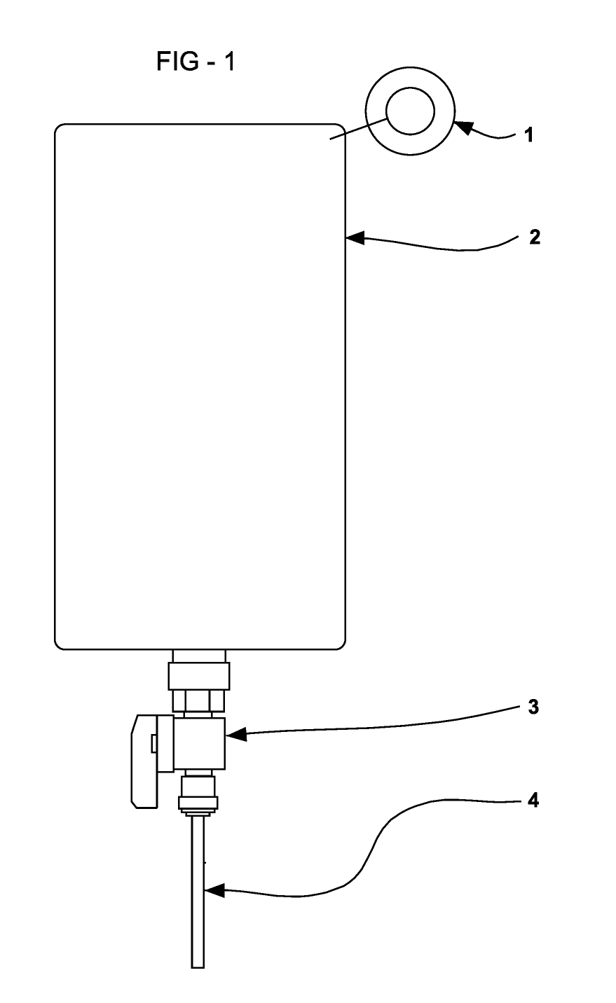

The invention represented in FIG. 1, consists of a collapsable plastic bladder 2, that is filled with water, and is suspended above the drill site. How this bladder is suspended is dependent on the circumstances. If the tile is smooth, the provided suction cup 1 that is attached to one corner of the bladder will be sufficient to hold its weight. At the bottom of the bladder is a valve 3, that allows the operator to adjust the water flow to provide the desired rate of flow to accomplish the cooling and debris removal. After the water leaves the valve it passes through a short piece of stiff hose 4, that points the water stream directly on the bit for cooling.

This invention allows the user to setup the device and then use both hands to drill the hole without the need to use one hand to drill and the other to dispense water. The previous method frequently resulted in the hole being drilled inaccurately, or potentially scarring the surface of the tile due to the drill bit shifting while the operator is trying to start the hole.

With the control valve 3, the user can adjust the flow of water to meet the cooling and debris removal requirements of the bit being used, allowing one device to be used with several size drill bits, unlike some devices already on the market.

It should be noted that after the specific invention was created and tested, it became apparent the this device could be used in many drilling and cutting situations, such as cutting metal or plastic, or drilling glass, allowing it to be used in many different industries. It should also be noted that subsequent versions of the invention could be constructed with fewer parts, or custom manufactured ones.

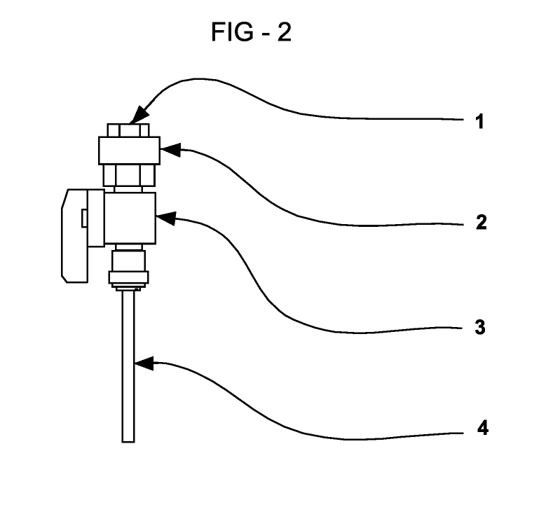

FIG. 2 is a detail of the valve assembly. A bulkhead union nut 1 was used from a ¼″×¼″ bulkhead union. The water bag cap 2 was drilled so that it fit snugly on the threaded end of a ¼″×¼″ NPTF Male Valve 3. The ¼″ stiff plastic tube 4 is inserted into the PTF (Push to fit) end of the ¼″×¼″ NPTF Male Valve.

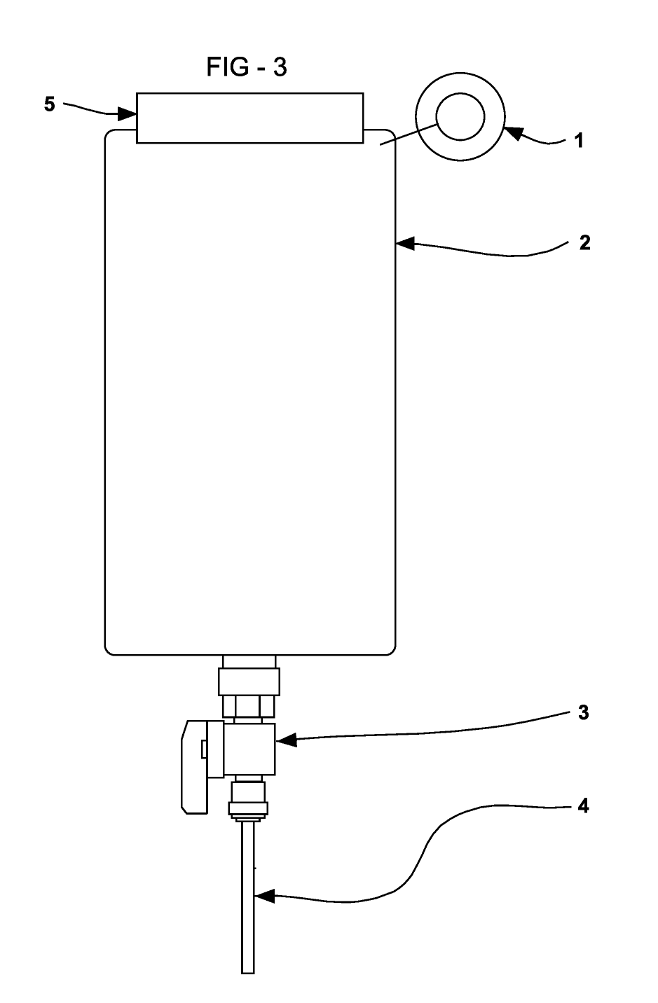

The embodiment of the invention represented in FIG. 3, consists of a collapsable plastic bladder 2, that is filled with water, and is suspended above the drill site. If the tile is smooth, the provided suction cup 1 that is attached to one corner of the bladder will be sufficient to hold its weight. If the tile is not smooth a short piece of tape, such as duct tape or something similar, will work nicely is shown as 5. At the bottom of the bladder is a valve 3, that allows the operator to adjust the water flow to provide the desired rate of flow to accomplish the cooling and debris removal. After the water leaves the valve it passes through a short piece of stiff hose 4, that points the water stream directly on the bit for cooling.

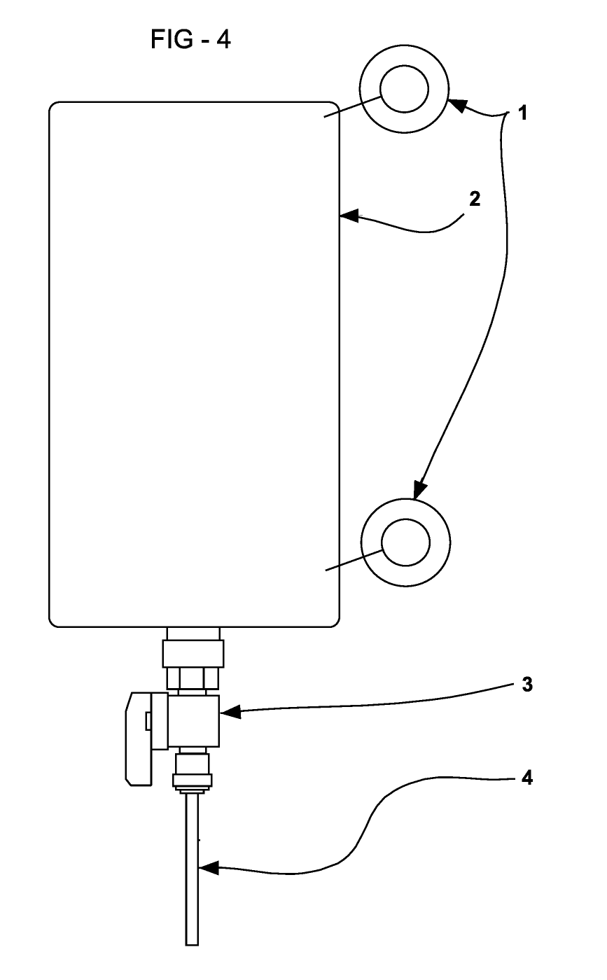

In FIG. 4 we see an additional embodiment of the invention. There are two suction cups 1 attached to the same side of the water filled bladder 2, to allow the hanging of the devise on and angle for use in tight spaces or very high drill sites where there would not be enough clearance to suspend the invention vertically. The same orientation could be achieved with tape if needed, but the tape placement is not shown. The control valve 3 and the stiff hose 4 are depicted as well.

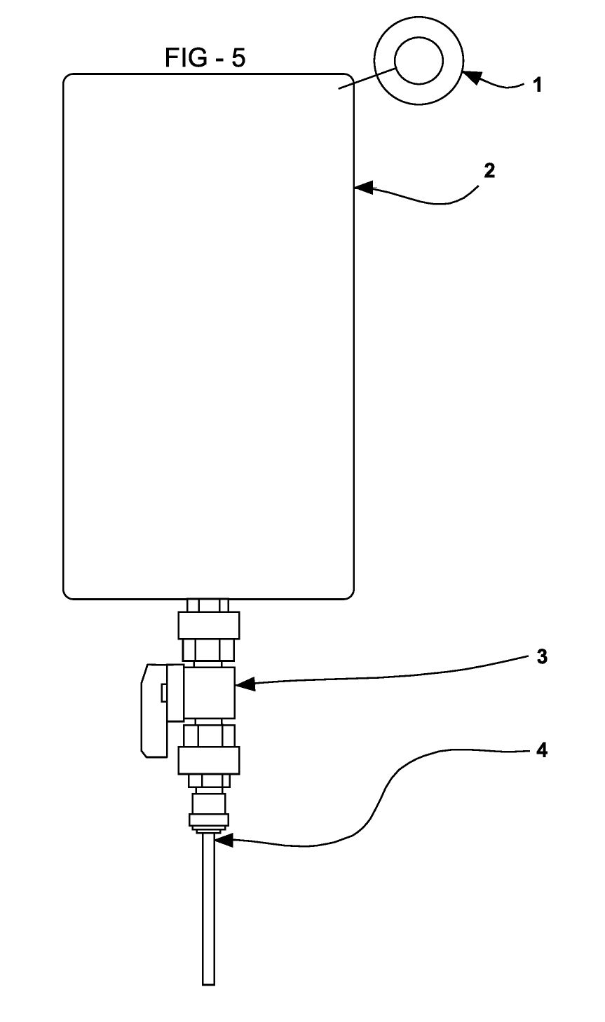

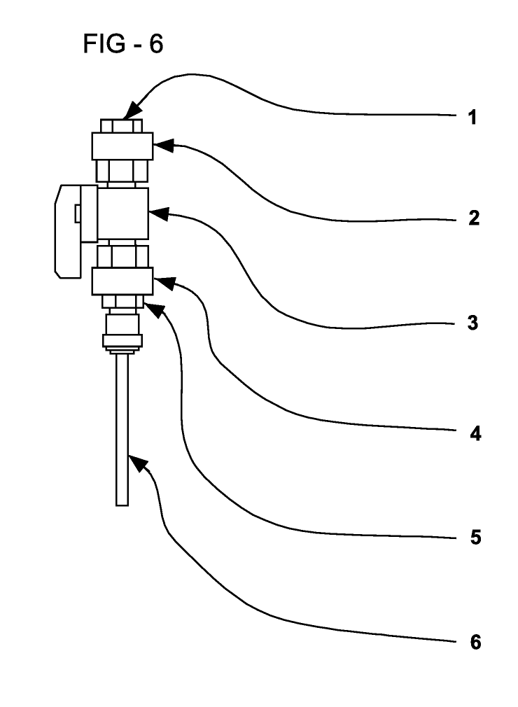

FIG. 5 depicts another embodiment of the invention. The water filled bladder 2 is suspended by the suction cup 1. Water is dispensed through the alternative control valve 3 and passes through the stiff tube 4. The control valve 3 is different in this embodiment, and explained in detail in the description of FIG. 6.

In FIG. 6 we have the detail of the alternate valve assembly. This embodiment was designed to provide the user with an easy way to fill the device on a construction site where running water might not be available. A bulkhead union nut 1 is used from a ¼″×¼″ bulkhead union. The water bag cap 2 was drilled so that it fit snugly on the threaded end of a ¼″×¼″ Male to Male Valve 3. A water bottle cap 4 is drilled and affixed to the other threaded end of the valve. A ¼″ NPTF Female adaptor 5 is used to securely attach the water bottle cap to the other threaded end of the valve. The ¼″ stiff plastic tube 6 is inserted into the PTF end of the ¼″ NPTF Female adaptor. This assembly affords the user the ability to refill the bladder with a water bottle on the job site, by dipping the stiff tube into an open, and filled, water bottle till the water bottle cap on the valve assembly is lined up the the threads of the water bottle. Tighten the cap onto the water bottle by turning the water bottle till snug. Open the control valve 3 and upend the device and water bottle so the water flows from the water bottle to the bladder. once it is filled, close the control valve 3 and remove the empty water bottle.

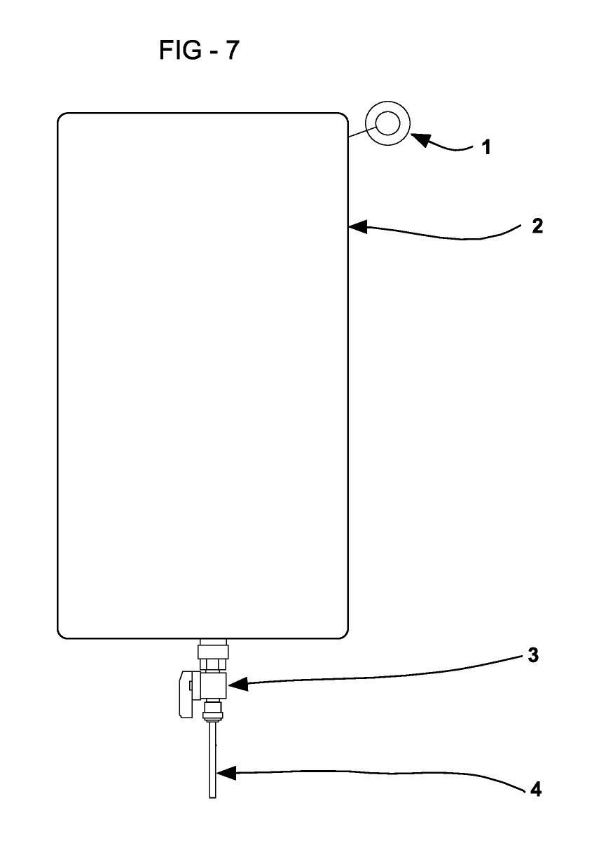

In FIG. 7 we have an embodiment of the device that has a larger capacity bladder 2 for the instances where bigger or deeper holes will need to be drilled, necessitating longer drill times. Also, it should be noted that a larger suction cup 1 will need to be employed. The same size control valve 3 and stiff hose 4 could still be used in most cases.

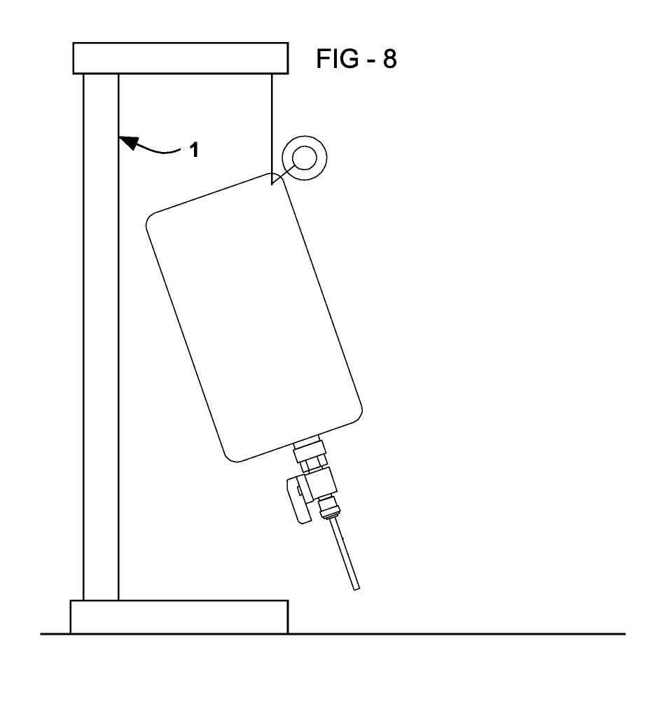

FIG. 8 depicts the preferred embodiment of the invention being suspended by a movable frame 1 in order to facilitate drilling vertically into countertops.

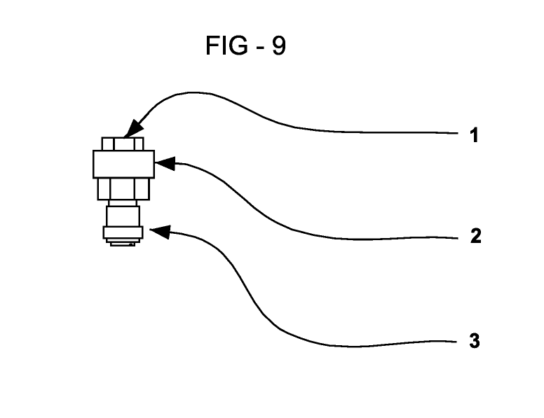

FIG. 9 depicts an on-site fill device designed to provide the user with an easy way to fill the invention on a construction site where running water might not be available. A bulkhead union nut 1 was used from a ¼″×¼″ bulkhead union. A water bottle cap 2, is drilled and fit snugly to the threaded end of ¼″×¼″ NPTF Male adaptor 3. The PTF end of the fill device is pushed onto the stiff tube of the preferred embodiment of the invention. An open and filled water bottle is maneuvered till the water bottle cap on the fill device assembly is lined up the the threads of the water bottle. Tighten the cap onto the water bottle by turning the water bottle till snug. open the control valve and upend the entire assembly and water bottle so the water flows from the water bottle to the bladder. Once it is filled, close the control valve and remove the empty water bottle. Then remove the on-site fill device from the stiff tube of the invention.

1. This device if used properly, will greatly extend the useful life of diamond drill bits used on stone tile.

2. After the invention is setup on the tile and the water flow adjusted, it affords the power drill operator greater control and safety, by its hands free operation in supplying cooling water and removing debris, it allows the operator to hold the drill with both hands while drilling, facilitating greater accuracy, control, and safety in drilling the hole where desired.
